(19) United States
(12) Patent Application Publication
(10) Pub. No.: US 2008/0185971 A1
(43) Pub. Date: Aug. 7, 2008

(54) Organic Electroluminescent Device Allowing Adjustment of Chromaticity

(75) Inventor: Masaru Kinoshita, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Kanagawa (JP)

(21) Appl. No.: 11/579,061

(22) PCT Filed: Apr. 30, 2004
(86) PCT No.: PCT/JP04/06354

§ 371 Date: Oct. 27, 2006

(51) Int. Cl. G09G 3/12

(52) U.S. Cl. 315/169.3

(57) ABSTRACT

An object of the invention is to provide an organic electroluminescent device emitting a light at an emission chromaticity properly adjusted while the luminescence brightness is kept constant. The organic electroluminescent device according to the invention, has an organic electroluminescence element having electrodes and an organic electroluminescent layer emitting white light at a chromaticity corresponding to the drive current density formed between the electrodes, and a drive unit driving the organic electroluminescence element while supplying current and controlling the drive current and the current-applying period per unit time in response to chromaticity adjustment input. And, the drive unit controls the drive current to be a first current and the current-applying period to be a first period respectively in response to a first chromaticity adjustment input, and controls the drive current to be a second current larger than the first current and the current-applying period to be a second period shorter than the first period respectively in response to a second chromaticity adjustment input, and adjusts the emission chromaticity of the light emitted while the luminescence brightness of the organic electroluminescence element is kept almost constant. In this way, in response to the chromaticity adjustment input for adjusting emission chromaticity, it is possible to adjust the emission chromaticity corresponding to the chromaticity adjustment input by controlling the drive current to the organic light-emitting element while keeping the luminescence brightness almost constant by adjusting the current-applying period per unit time according to the control of the drive current, thereby the light emission is adjusted to a desired emission chromaticity without change in luminescence brightness.

### TECHNICAL FIELD

The invention relates to an organic electroluminescent device and in particular, to an organic electroluminescent device with white luminescence allowing the chromaticity arrangement while preserving its white brightness.

### RELATED ART

Organic electroluminescence (EL) elements, which emit light on their own (selfluminous light) by current driving and respond rapidly to current driving (high speed response), have a potential for application to flat panel display devices. On the other hand, organic EL elements are also thin and light and allow uniform emission in a large area, and can be applied to lighting devices.

Since a laminated element of hole-transporting and electron-transporting organic thin layers was disclosed (C. W. Tang and S. A. VanSlyke, Applied Physics Letters, Vol. 51, 913 (1937) (hereinafter, referred to as Non-patent Document 1)), organic EL elements are attracting attention as a large-area light-emitting device emitting light at a low voltage of 10 V or lower. Such a laminated organic EL element fundamentally has a laminate structure of positive electrode, hole-transporting layer, light-emitting layer, electron-transporting layer, and negative electrode. In such a case, the hole-transporting layer or electron-transporting layer may also have a function as the light-emitting layer, as in the bilayer element disclosed in the Non-patent Document 1. In addition to a single film of one kind of material, a colorant-doped film having a highly fluorescent colorant molecule (guest material) doped in a principal host material in a small amount was proposed for a configuration of the light-emitting layer in order to obtain a high-luminous organic EL element (C. W. Tang, S. A. VanSlyke, and C. H. Chen, Applied Physics Letters, Vol. 65, 3610 (1939) (hereinafter, referred to as Non-patent Document 2)).

Alternatively, a display device emitting a monochromatic light by using an organic EL element was proposed (for example, Japanese Patent Application Laid-Open (JP-A) No. 2003-234181, (hereinafter Patent Document 1)). Patent Document 1 above disclosed an organic EL display device having pixels formed on a white light-emitting matrix that is formed by placing blue light- and yellow light-emitting layers between hole-injecting layers and electron-injecting layers. It also disclosed brightness adjustment by modulation of emission pulse width without changing the emission chromaticity while keeping the drive voltage constant.

### SUMMARY OF THE INVENTION

However, in the prior arts, Non-patent Documents 1 and 2 and Patent Document 1, there is no description on the lighting or display device using white luminescence that can adjust its chromaticity while keeping its luminescence brightness at a constant level.

Accordingly, an object of the invention is to provide an organic electroluminescent device allowing adjustment of its emission chromaticity while keeping its luminescence brightness constant.

An aspect of the invention provides an organic electroluminescent device, comprising an organic electroluminescence element having an organic electroluminescent layer formed between electrodes. The organic electroluminescent layer emits white light at a chromaticity corresponding to a drive current density, and a drive unit drives the organic electroluminescence element by application of current and controls a drive current and a current-applying period per unit of time according to a chromaticity adjustment input. The drive unit controls respectively the drive current to be a first current and the current-applying period to be a first period in response to a first chromaticity adjustment input, and controls the drive current to be a second current larger than the first current and the current-applying period to be a second period shorter than the first period in response to a second chromaticity adjustment input.

The above aspect provides an organic electroluminescent device that can adjust the emission chromaticity to a value corresponding to the chromaticity adjustment input by controlling the drive current to the organic light-emitting element in response to a chromaticity adjustment input for adjustment of emission chromaticity, keep the luminescence brightness almost constant by adjusting the current-applying period per unit of time according to the control of the drive current, and adjust the emission chromaticity to a desirable value without alteration of luminescence brightness. The organic electroluminescent device can be used as a lighting device or a backlight for liquid crystal display devices. The organic electroluminescent device can also be used as an emission segment in segment display devices.

Although a method of controlling chromaticity by adjustment of drive current adjustment is described in the invention, the chromaticity control may be performed by adjustment of drive voltage. Because the voltage and the current of an organic EL element is related to each other, it is possible to adjust chromaticity similarly by changing the voltage to a value that leads to the desirable current density disclosed in the invention.

### BRIEF DESCRIPTION OF THE DRAWINGS

FIG. 1 is a chart showing the configuration of the organic electroluminescent device according to an embodiment.

FIG. 2 is a chart showing the configuration of the drive unit according to an embodiment.

FIG. 3 is a chart showing the relationship between the current density and the emission chromaticity of organic EL layer.

FIG. 4 is a chart showing the relationship between the current density and the luminescence brightness of organic EL layer.

FIG. 5 is a chart showing an example of the drive pulse in the organic EL element according to an embodiment.

FIG. 6 is a chart showing the configuration of the organic EL device in an exemplary example.

FIG. 7 is a chart showing the configuration of the organic EL device in an exemplary example.

FIG. 8 include tables showing the relationship of the current density and duty ratio of the prepared organic EL element with the normalized average brightness and the chromaticity values x and y.

FIG. 9 is a chart showing the structural formulae of the organic materials used.

FIG. 10 is a chart showing the configuration of another drive unit according to an embodiment.

### BEST MODE FOR CARRYING OUT THE INVENTION

Hereinafter, favorable embodiments of the invention will be described with reference to drawings.

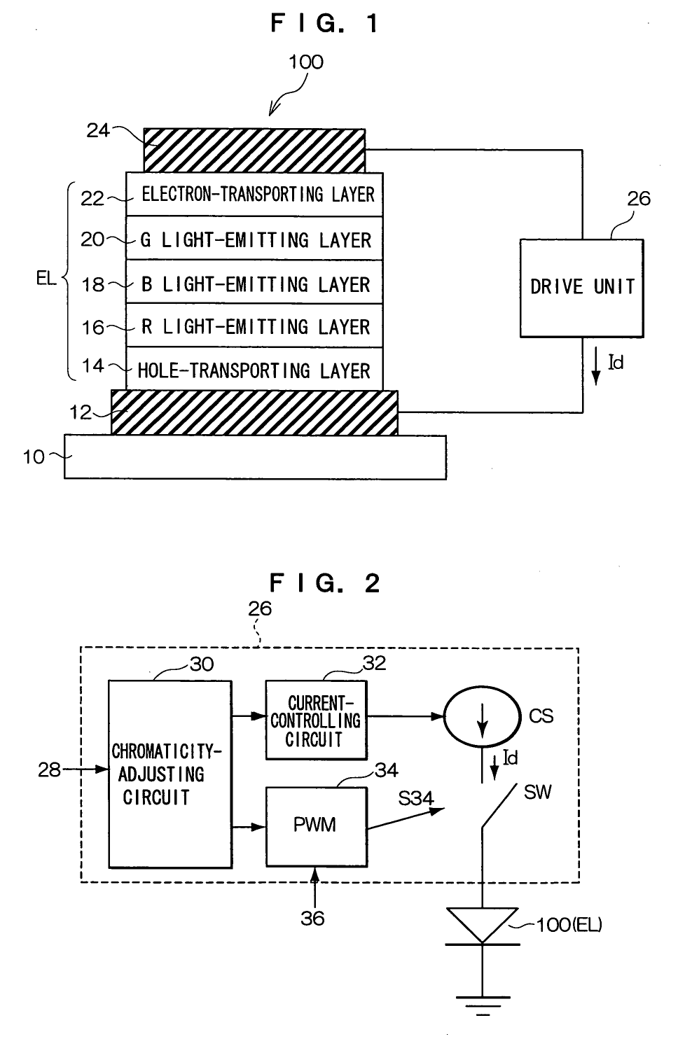

FIG. 1 is a chart showing the configuration of the organic electroluminescent device in the present embodiment. The organic EL device has a transparent substrate 10, and an organic EL element 100 formed thereon having transparent electrodes, an anode layer 12 for example of ITO and a cathode layer 24 for example of aluminum, white-light-emitting organic EL layers formed between the anode layer 12 and the cathode layer 24, and a drive unit 26 connected to the anode layer 12 and the cathode layer 24 supplying drive current Id. The white-light-emitting organic EL layer has a hole-transporting layer 14 supplying holes from the anode layer 12, an electron-transporting layer 22 supplying electrons from the cathode layer 24, and a light-emitting layer consisting of a red light-emitting layer 16, a blue light-emitting layer 18, and green light-emitting layer 20 formed between the transporting layers. These layers 14 to 22 are organic material layers. Presence of the hole-transporting layer 14 and the electron-transporting layer 22 between the light-emitting layer and the electrodes is effective in giving the device high luminous efficiency.

The light-emitting layer preferably emits white luminescence, and it is possible to obtain white light emission by adding multiple colorants, for example three kinds of colorants giving red, blue, and green emission, into the light-emitting layer. The light-emitting layer may not have a three-layer structure of red, blue, and green light-emitting layers as shown in FIG. 1, and may be a single organic material layer giving red and blue, blue and green, or green and red emission, as will be described below. Alternatively, it may be a single organic material layer giving all red, blue, and green emission.

Yet alternatively, it may be a light-emitting layer common to the hole-transporting layer 14 or the electron-transporting layer 22. Thus, the device may have a configuration of hole-transporting layer with light-emitting and electron-transporting layer or of hole-transporting and light-emitting layer with electron-transporting layer.

FIG. 2 is a structural drawing showing the drive unit in the present embodiment. The drive unit 26 has a current source CS supplying current Id to the organic EL element 100, a drive switch SW connecting the current source CS to the organic EL element 100 and supplying the drive current Id, a current-controlling circuit 32 controlling the current Id of the current source CS according to a chromaticity adjustment input 28, an driving time-controlling circuit 34 controlling the connecting time of the drive switch SW according to the chromaticity adjustment input 28, and a chromaticity-adjusting circuit 30 controlling the current-controlling circuit 32 and driving time-controlling circuit 34. The current-controlling circuit 32 controls the drive current Id of the current source CS, and the driving time-controlling circuit 34 performs pulse width modulation (PWM) of the connection drive signal S34 of the drive switch SW. The chromaticity-adjusting circuit 30, current-controlling circuit 32, and driving time-controlling circuit 34 control, according to the chromaticity adjustment input 28, the current to a particular drive current Id corresponding to adjusted emission chromaticity and turn on the drive switch SW for a particular drive period per unit time to make the luminescence brightness almost constant with the controlled drive current Id.

When the area of the organic EL element 100 is constant, the drive current density can be altered by adjustment of the drive current Id. And, as will be described below, the emission chromaticity can be altered by adjustment of the drive current density.

FIG. 10 is a chart showing the configuration of a modification of the drive unit shown in FIG. 2. It is different from the drive unit of FIG. 2 in that the current source is replaced with a voltage source VS and the current-controlling circuit 32 with a voltage-controlling circuit 32V. Thus, the drive current Id supplied to the organic EL element is altered by adjustment of the voltage of voltage source VS by the voltage-controlling circuit 32V, and the EL element is driven at a desired current density thereby. Other operation is the same as that in FIG. 2.

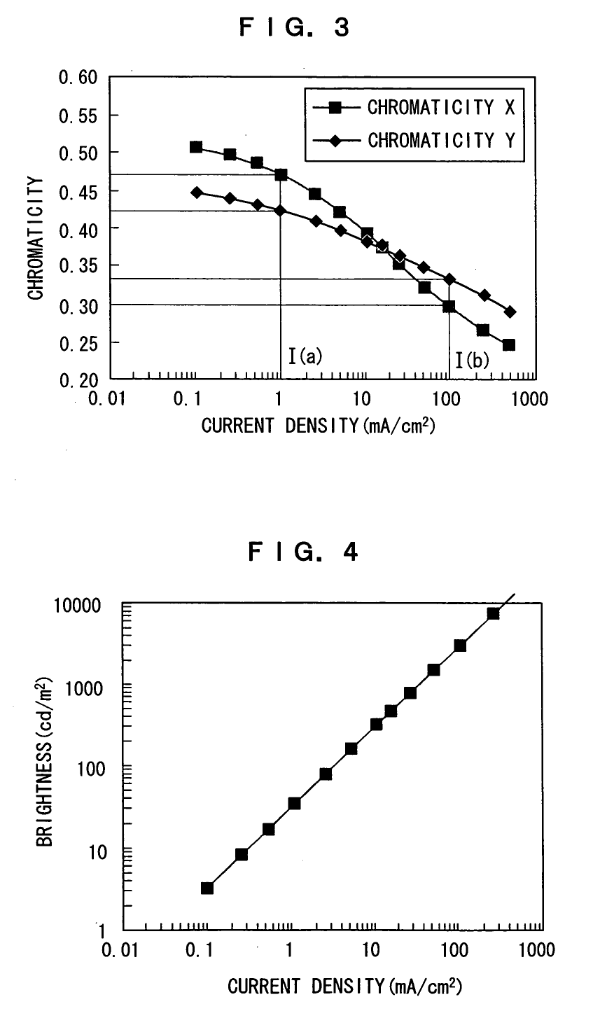

FIG. 3 is a chart showing the relationship between the current density and the emission chromaticity of organic EL layer. The inventors have found that, when the current density supplied to the organic EL element shown in FIG. 1 was altered, the chromaticity of the white light emitted changed, as shown in the Figure. Thus, in an organic EL element emitting R, G, and B lights simultaneously, the chromaticity of the white light emitted changes by change of current density. In the example of FIG. 3, each chromaticity (x, y) is (0.52, 0.45) when the current density is low, while each chromaticity (x, y) is (0.25, 0.30) when the current density is high. That is, the emission chromaticity (x, y) changes between (0.52, 0.45) and (0.25, 0.30), when the current density is altered.

Primary reasons for the change in chromaticity seem that the emission position in organic EL layer changes by the change of drive current or drive voltage, and that the emission initiation voltage varies according to the emission color. The organic electroluminescent device in the present embodiment employs an organic EL element that changes the chromaticity of emitted white light according to the change in drive current density corresponding to the change in drive current or drive voltage.

FIG. 4 is a chart showing the relationship between the current density and the luminescence brightness of organic EL layer. As shown in the Figure, change in current density for adjustment of emission chromaticity is accompanied with linear change in luminescence brightness. Thus, in the present embodiment, the drive unit supplies drive current to the organic EL element by pulse driving. When the current density is altered for adjustment of emission chromaticity, the emission period per unit time is adjusted by altering the duty ratio of drive according to the altered current density, thereby the luminescence brightness per unit time constant. Thus, when the current density is reduced, the decrease in brightness associated with the reduction in current density is compensated by increase of duty ratio, i.e., elongation of the emission period in intermittent emission; and, when the current density is raised, the increase in brightness associated with the increase in current density is compensated by reduction of duty ratio, i.e., shortening of the emission period in intermittent emission.

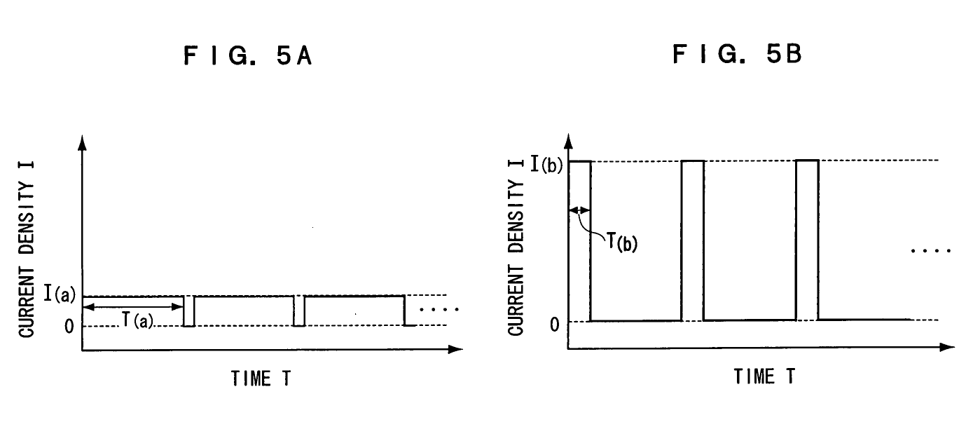

FIG. 5 is a chart showing examples of the drive pulses for the organic EL element in the present embodiment. FIG. 5A shows a drive pulse when the current density is controlled low. The pulse width T (a) in the drive pulse is set to be longer, and the duty ratio higher. By supplying such a drive pulse, although the luminescence brightness per unit time becomes lower at low current density, the time-averaged luminescence brightness reaches a particular value because the emission period per unit time is elongated. FIG. 5B shows a drive pulse when the current density is controlled higher. The pulse width T (b) of the drive pulse is set to be shorter and the duty ratio lower. By supplying such a drive pulse, although the luminescence brightness per unit time becomes higher at high current density, but the time-averaged luminescence brightness can be controlled to be equivalent to the particular value shown in FIG. 5 (a) because the emission period per unit time is shortened. The range of the change in emission chromaticity depends on the organic EL element's chromaticity change characteristics, and the configuration of the element is optimized previously to give a desirable chromaticity change range.

Thus, in the present embodiment, the emission chromaticity is adjusted by controlling the drive current density upward or downward according to the adjustment input and controlling the pulse width of the drive pulse according to the control of drive current density.

On the other hand, when the luminescence brightness is adjusted in organic EL device of the present embodiment, the pulse width of the drive pulse is adjusted without alteration of the current density in response to the luminescence brightness adjustment input 36, as shown in FIG. 2. The pulse width of drive pulse is controlled to be shorter in response to a luminescence brightness adjustment input demanding decrease of luminescence brightness, while the pulse width of drive pulse is controlled to be longer in response to a luminescence brightness adjustment input demanding increase of luminescence brightness. In this way, it is possible to adjust the luminescence brightness according to the luminescence brightness adjustment input, while retaining the emission chromaticity at a desired chromaticity.

Thus in organic EL device of the present embodiment, the emission chromaticity is adjusted according to the emission chromaticity adjustment input 28, independently of the luminescence brightness, and the luminescence brightness is adjusted according to the luminescence brightness adjustment input 36, independently of the emission chromaticity.

Chromaticity adjustment in conventional organic EL display device will be described for reference. The conventional organic EL display device has organic EL elements emitting R, C; and B lights in each pixel. The red-, blue-, and green-light-emitting organic EL elements are current-driven independently. Accordingly, it is necessary to make all R, C; and B organic EL elements in operation for obtaining white luminescence, and further, to adjust the luminescence brightness of respective organic EL elements and balance the emission lights into the white light having a desirable chromaticity, for adjustment of the chromaticity of the white luminescence.

In addition, for regulation of the white chromaticity when white light is emitted from the entire surface of a full color liquid crystal display device, it is necessary to control the light to a desirable chromaticity, by adjusting the transmission characteristics of liquid crystal layer while adjusting the drive voltage to the RGB pixels in the liquid crystal layer. Thus, adjustment of chromaticity when white light is emitted on the entire surface of an organic EL display device or liquid crystal display device is complicated.

In contrast, in the organic EL device of the present embodiment, it is possible to obtain white luminescence at a desired emission chromaticity while keeping the brightness at a particular level in a simple configuration, because a single organic EL element gives white luminescence and the emission chromaticity changes simply by alteration of the current density.

### FIRST EXAMPLE

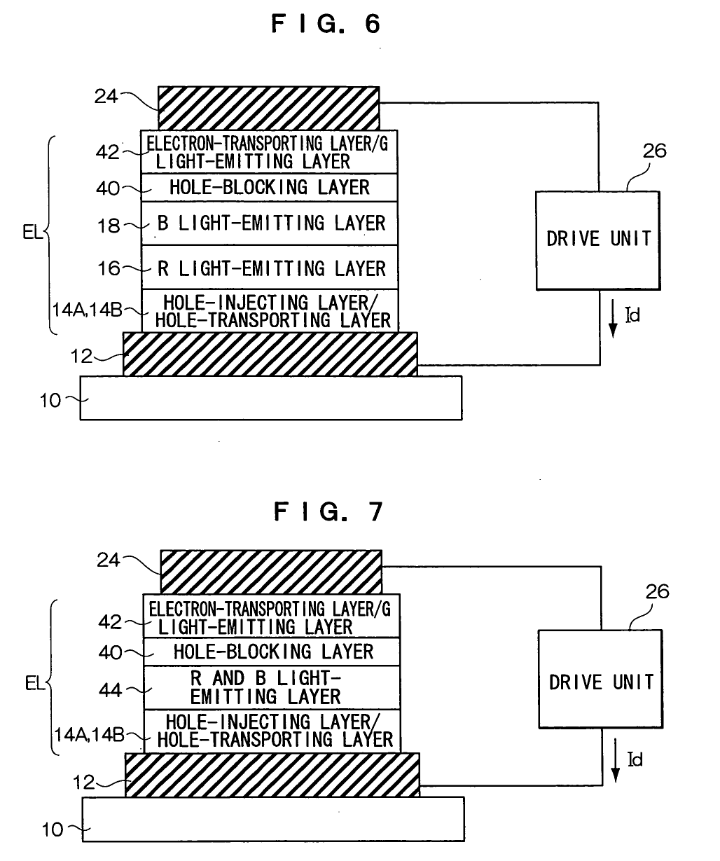

FIG. 6 is a chart showing the configuration of the organic EL device in the first example. The organic EL element in this example has an organic EL layer consisting of a hole-injecting layer 14A, a hole-transporting layer 14B, a red light-emitting layer 16, a blue light-emitting layer 18, a hole-blocking layer 40, and an electron-transporting and green light-emitting layer 42. The structure is prepared in the following way:

First, a glass substrate 10 carrying an ITO electrode 12 previously formed thereon is ultrasonicated and cleaned in water, acetone, and isopropyl alcohol, and treated with far ultraviolet ray (UV) and ozone; then, in a vacuum evaporator (1×10⁻⁶ torr, substrate temperature: room temperature), 2-TNATA (4,4′,4″-tris(2-naphthylphenylamino) triphenylamine) is deposited thereon as the hole-injecting layer 14A to a thickness of 140 nm, then α-NPD (N,N′-dinaphthyl-N,N′-diphenyl-[1,1′-biphenyl]-4,4′-diamine) is deposited thereon as the hole-transporting layer 14B to a thickness of 10 nm. On the two layers 14A and 14B is formed a layer of a guest material DCJTB (4-dicyanomethylene-6-cp-julolidinostyryl-2-tert-butyl-4H-pyran) and a host material Alq₃ (tris(8-hydroxyquinolinato)aluminum) is codeposited (vapor deposition ratio: DCJTB:Alq₃ of 1:99 by mole) to a thickness of 1 nm so as to form the red light-emitting layer 16; on top of this a layer of a guest material t(bp)py (1,3,6,8-tetrabiphenylpyrene) and a host material CBP (4,4′-bis(9-carbazolyl)-biphenyl) is codeposited (vapor deposition ratio t(bp)py: CBP of 10:90 by mole) is formed thereon to a thickness of 20 nm to form the blue light-emitting layer 18; on top of this BAlq is deposited thereon as the hole blocking layer 40 to a thickness of 10 nm; Alq₃ is deposited thereon as the green light-emitting and electron-transporting layer 42 to a thickness of 30 nm; lithium fluoride is deposited thereon to a thickness of 0.5 nm; and Al is deposited thereon as the cathode layer 24 to a thickness of 100 nm. The lithium fluoride layer is to strengthen the electron-injecting function of the green light-emitting and electron-transporting layer 42. The hole blocking layer 40 has a function of blocking some of the holes supplied from the hole-transporting layer 14B and reducing the number of the holes supplied to the green light-emitting layer 42.

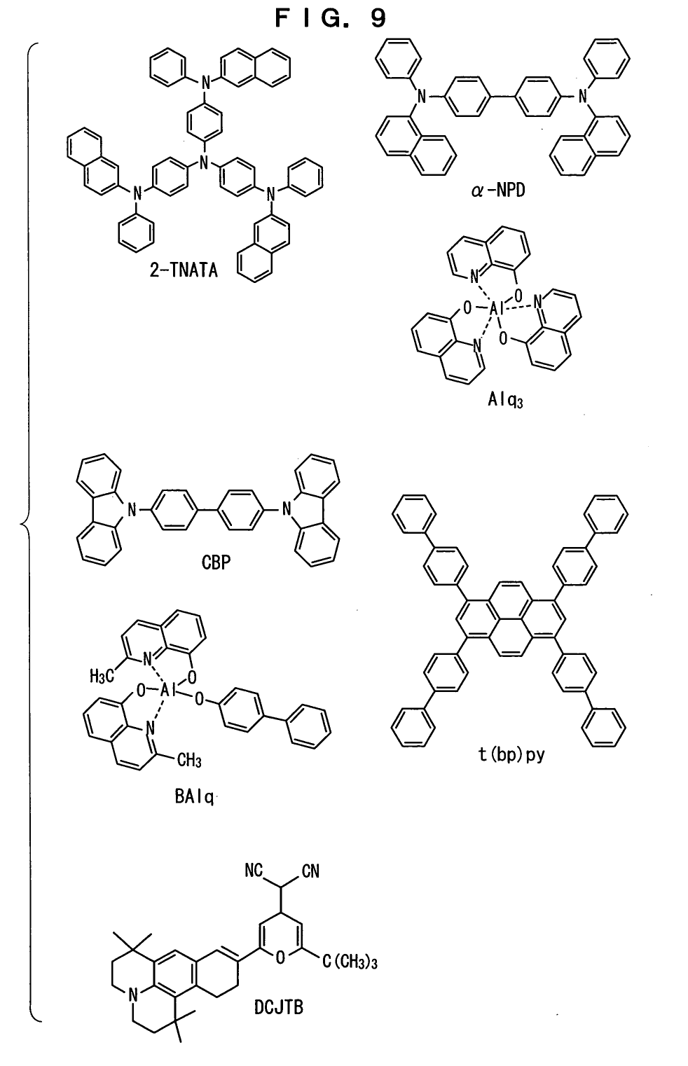

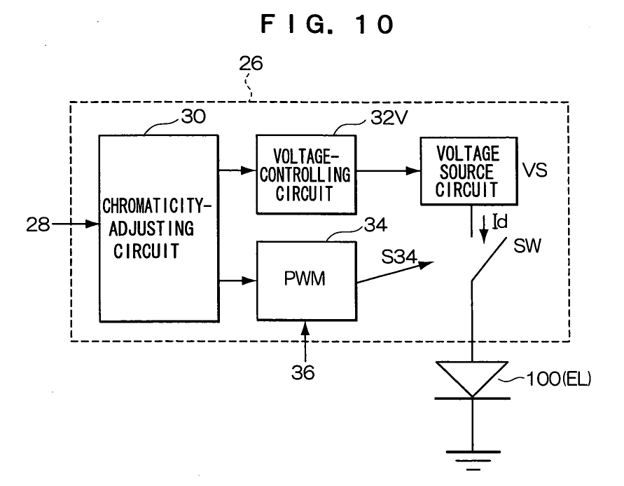

The organic materials 2-TNATA, α-NPD, DCJTB, Alq₃, t(bp)py, CBP, and Balq are materials represented by the structural formulae shown in FIG. 9.

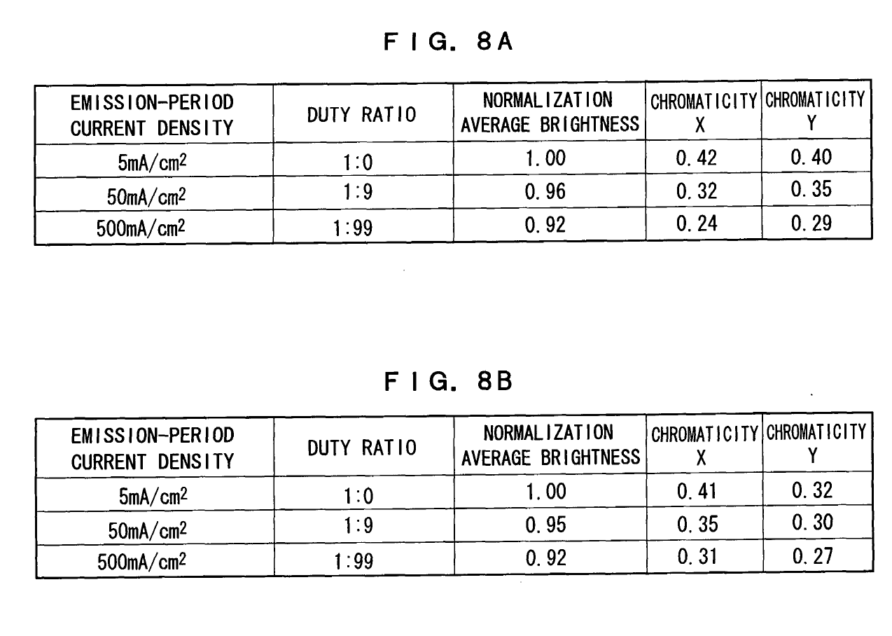

FIG. 8A include a table showing the relationship of the current density and duty ratio of the prepared organic EL element with the normalized average brightness and the chromaticity values x and y. FIG. 8A shows the results of the organic EL element in the first embodiment. As described above, the organic EL element prepared was driven by changing the applied current to instantaneous current densities of 5 mA/cm², 50 mA/cm², or 500 mA/cm² during emission, and changing the drive duty ratios (emission period: termination period) to (1:0), (1:9), or (1:99). FIG. 8A shows the relationship between the time-averaged brightness and the emission chromaticity when setting a current density of 5 mA/cm² as the reference. As shown in the table, it is possible to adjust the chromaticity by altering the current density and to keep the brightness at a particular level by adjusting the duty ratio of the drive pulse according to the current density.

### SECOND EXAMPLE

FIG. 7 is a chart showing the configuration of the organic EL device in the second example. The organic EL element in this example has an organic EL layer consisting of a hole-injecting layer 14A, a hole-transporting layer 14B, a red and blue light-emitting layer 44, a hole-blocking layer 40, and an electron-transporting and green light-emitting layer 42. The structure is prepared in the following way:

First, a glass substrate 10 carrying an ITO electrode formed thereon is ultrasonicated and cleaned in water, acetone, and isopropyl alcohol and treated with UV and ozone; in a vacuum evaporator (1×10⁻⁶ torr, substrate temperature: room temperature), 2-TNATA is deposited thereon to a thickness of 140 nm so as to form the hole-injecting layer 14A, and α-NPD is deposited thereon to form the hole-transporting layer 14B to a thickness of 10 nm. A layer of a blue guest material t(bp)py, a red guest material DCJTB, and a host material CBP codeposited (vapor deposition ratio t(bp)py:DCJTB:CBP: 10:1:89 by mole) is formed on the two layers 14A and 14B to form the blue and red light-emitting layer 44 to a thickness of 20 nm; BAlq is deposited thereon to form the hole blocking layer 40 to a thickness of 10 nm; Alq₃ is deposited thereon to form the green light-emitting and electron-transporting layer 42 to a thickness of 30 nm; lithium fluoride is deposited thereon to a thickness of 0.5 nm; and Al is deposited thereon to form the cathode layer 24 to a thickness of 100 nm. Each material is represented by the structural formula shown in FIG. 9.

As shown in the table of FIG. 8B, the organic EL element prepared was driven by changing the applied current to instantaneous current densities of 5 mA/cm², 50 mA/cm², or 500 mA/cm² during emission and changing the drive duty ratios (emission period: termination period) to (1:0), (1:9), or (1:99). FIG. 8B shows the relationship between the time-averaged brightness and the emission chromaticity when setting a current density of 5 mA/cm² as the reference. As shown in the table, it is possible to adjust the chromaticity by altering the current density and to keep the brightness at a particular level at the same time.

As shown in FIGS. 6, and 7, the organic EL device in the present embodiments has a white light-emitting organic EL layer formed between a pair of electrodes, and the white light from the organic EL layer changes its chromaticity according to the drive current density. It is possible to provide a white lighting device by forming an organic EL element having such an organic EL layer in a particular area. The white lighting device can be used, for example, as a lighting device replacing fluorescent lamp, or as a backlight for liquid crystal display device, because the white lighting device is thin, light, and capable of uniform surface emission.

In addition, the organic EL device in the present embodiment can also be used as a segment display device that displays alphabetic characters by allowing selective emission of multiple segments.

### INDUSTRIAL APPLICABILITY

The invention provides an organic EL device emitting a light at a desired emission chromaticity properly adjusted while the luminescence brightness is kept at a particular level. The organic EL device can be used as a lighting device and also as a display device.

1. An organic electroluminescent device, comprising:
an organic electroluminescence element having electrodes, and, formed between the electrodes, an organic electroluminescent layer emitting white light at a chromaticity corresponding to a drive current density; and
a drive unit driving the organic electroluminescence element by application of current and controlling the drive current and the current-applying period per unit of time according to a chromaticity adjustment input, wherein
in response to a first chromaticity adjustment input the drive unit controls, respectively, the drive current to be a first current and the current-applying period to be a first period, and in response to a second chromaticity adjustment input the drive unit controls, respectively, the drive current to be a second current larger than the first current and the current-applying period to be a second period shorter than the first period.

2. An organic electroluminescent device, comprising:
an organic electroluminescence element having electrodes, and formed between the electrodes an organic electroluminescent layer emitting white light at a chromaticity corresponding to a drive current density; and
a drive unit driving the organic electroluminescence element at a particular drive voltage and controlling the drive voltage and the voltage-applying period per unit time in response to a chromaticity adjustment input, wherein
in response to a first chromaticity adjustment input the drive unit controls, respectively, the drive current to be a first current and the voltage-applying period to be a first period, and in response to a second chromaticity adjustment input controls, respectively, the drive current to be a second current larger than the first current and the voltage-applying period to be a second period shorter than the first period.

3. The organic electroluminescent device according to claim 1, wherein the organic electroluminescent layer emits light of multiple emission colors that enable white luminescence in combination.

4. The organic electroluminescent device according to claim 3, wherein the organic electroluminescent layer emits lights of red, blue, and green simultaneously.

5. The organic electroluminescent device according to claim 3, wherein the organic electroluminescent layer comprises red, blue, and green light-emitting layers.

6. The organic electroluminescent device according to claim 3, wherein the organic electroluminescent layer comprises a red light-emitting layer and a blue and green light-emitting layer.

7. The organic electroluminescent device according to claim 3, wherein the organic electroluminescent layer comprises a red and blue light-emitting layer and a green light-emitting layer.

8. The organic electroluminescent device according to claim 3, wherein the organic electroluminescent layer comprises a red and green light-emitting layer and a blue light-emitting layer.

9. The organic electroluminescent device according to any one of claim 4, wherein the organic electroluminescent layer comprises a hole-transporting layer and an electron-transporting layer, both layers being provided in contact with the electrodes.

10. The organic electroluminescent device according to claim 1, wherein the drive unit comprises a current source, a drive switch connecting the current source to the organic electroluminescence element, a current-controlling circuit controlling the current of the current source in response to the chromaticity adjustment input, and a driving time-controlling circuit controlling the connection period of the drive switch in response to the chromaticity adjustment input.

11. The organic electroluminescent device according to claim 2, wherein the drive unit comprises a voltage source, a drive switch connecting the voltage source to the organic electroluminescence element, a voltage-controlling circuit controlling the voltage of the voltage source in response to the chromaticity adjustment input, a driving time-controlling circuit controlling the connection period of the drive switch in response to the chromaticity adjustment input.

12. A liquid crystal display device, comprising: the organic electroluminescent device of claim 1, as a backlight unit; and a liquid crystal layer formed on the organic electroluminescent device.
